(19) United States
(12) Patent Application Publication
(10) Pub. No.: US 2012/0173886 A1
(43) Pub. Date: Jul. 5, 2012

(54) ELECTRONIC DEVICE WITH A FILE AUTHORIZATION MANAGEMENT FUNCTION AND METHOD THEREOF

(75) Inventors: QIANG YOU, Shenzhen City (CN); XIAN-ZENG HUANG, Shenzhen City (CN); JUN ZHANG, Shenzhen City (CN); JUN-WEI ZHANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/163,738

(22) Filed: Jun. 20, 2011

(30) Foreign Application Priority Data
Dec. 31, 2010 (CN) 201010619790.3

(51) Int. Cl. G06F 12/14; G06F 7/04

(52) U.S. Cl. 713/193

(57) ABSTRACT

An electronic device for managing file authorization is provided. The electronic device stores encrypted files. Each encrypted file presets a predetermined password. When receiving an operation signal of one of the encrypted file, the electronic device determines whether the operation signal matches the predetermined password of the selected file. The electronic device processes the file in response to the operation signal if the input matches the predetermined password of the selected file, and does not respond to the operation of the selected file if the input does not match the predetermined password of the selected file.

### BACKGROUND

1. Technical Field

The present disclosure relates to an electronic device with a file authorization management function and a method thereof.

2. Description of Related Art

Generally, important or private files stored in an electronic device, such as a computer, a cell-phone, or a PDA, are encrypted to prevent unwanted exposure of these files. When opening the encrypted file, a dialog box will be generated to prompt the user to input a predetermined password. When the input password matches the preset password, the file is then decrypted and can be accessed by an authorization user. However, sometimes one does not desire to reveal whether the files are encrypted or not, therefore, there is room for improvement in the art.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with a file authorization management function in accordance with an exemplary embodiment.

FIG. 2 is a flowchart of a file authorization managing method, in accordance with an embodiment, applied on the electronic device of FIG. 1.

### DETAILED DESCRIPTION

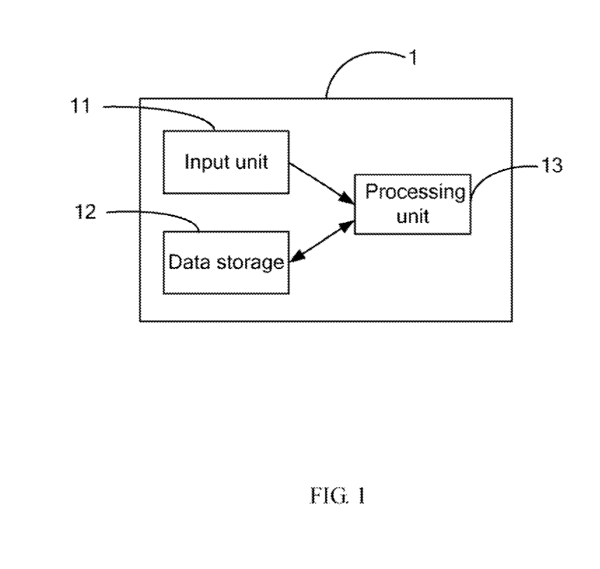

FIG. 1 is a block diagram of an electronic device 1 with a file authorization management function in accordance with an exemplary embodiment. The electronic device 1 includes an input unit 11, a data storage 12, and a processing unit 13. The input unit 11 is for generating operation signals in response to the operation of the users. The data storage 12 stores encrypted files and a predetermined password set for each encrypted file.

The processing unit 13 selects a file in response to a file selection operation input through the input unit 11. When receiving an operation signal, such as opening, copying, or deleting of the selected file from the input unit 11, the processing unit 13 determines whether the selected file is an encrypted file. If the selected file is the encrypted file, the processing unit 13 receives input(s) through the input unit 11 and determines whether the input(s) matches the predetermined password of the selected file. If the input(s) matches the predetermined password of the selected file, the processing unit 13 processes the file in response to the operation signal. If the input(s) does not match the predetermined password of the selected file, then the processing unit 13 does not respond to the operation of the selected file. Thereby, when unauthorized user tries to access the encrypted file, the unauthorized user will not know the file is an encrypted file because no prompting of the password will be generated.

The predetermined password set for each encrypted file can be a combination of characters, an operation on a function key, or a combination of function keys, such as an enter key, a shift key, or a combination of the enter key and the shift key.

In the present embodiment, the input order of the input elements corresponds to the set order of elements of the predetermined password, when receiving one input element from the input unit, the processing unit compares the input element with the corresponding element of the input element in the predetermined password. If the input element does not match the corresponding input element of the predetermined password, then the processing unit 13 determines the input(s) does not match the predetermined password.

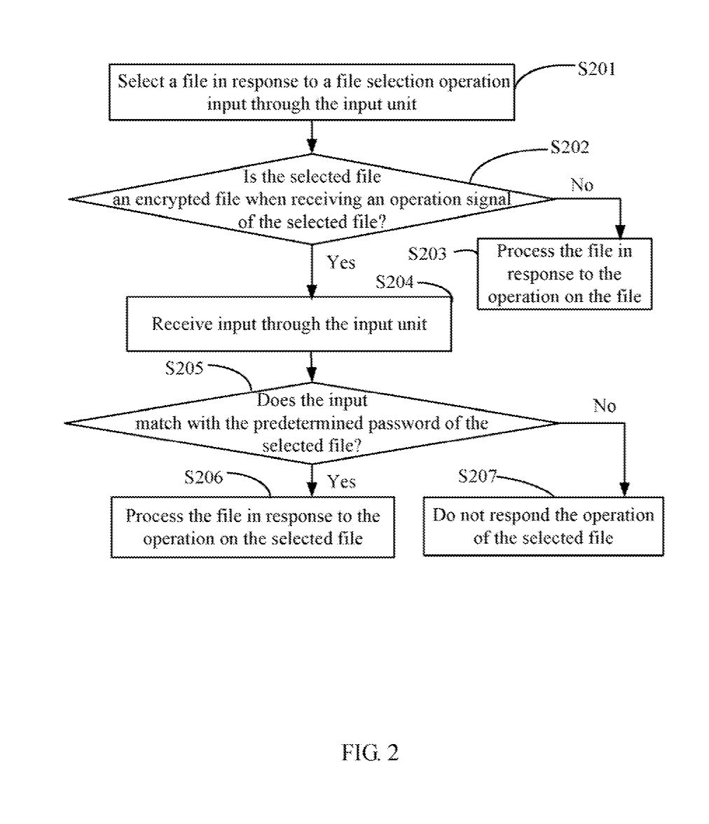

FIG. 2 is a flow chart of a file authorization managing method applied on the electronic device of FIG. 1.

In step S201, the processing unit 13 selects a file in response to a file selection operation input through the input unit 11.

In step S202, when receiving an operation signal for the selected file from the input unit 11, the processing unit 13 determines whether the selected file is an encrypted file.

In step S203, if the selected file is not the encrypted file, the processing unit 13 processes the file in response to the operation on the file.

In step S204, if the selected file is an encrypted file, the processing unit 13 receives the input(s) through the input unit 11

In step S205, the processing unit 13 determines whether the input(s) matches with the predetermined password of the selected file.

In step S206, if the input(s) matches with the predetermined password of the selected file, the processing unit 13 processes the file in response to the operation on the selected file.

In step S207, if the input(s) does not match the predetermined password of the selected file, the processing unit 13 does not respond to the operation on the selected file.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with a file authorization management function, comprising:
an input unit for generating operation signals in response to user's operations;
a data storage for storing at least one encrypted file and at least one predetermined password, each of the at least one encrypted file corresponding to one of the at least one predetermined password; and
a processing unit for selecting a file in response to a file selection operation input through the input unit, determining whether the selected file is an encrypted file when receiving an operation signal of the selected file from the input unit, receiving input through the input unit if the selected file is an encrypted file, determining whether the input matches the predetermined password corresponding to the encrypted file, processing the file in response to the operation signal if the input matches the predetermined password of the selected file, and not responding to the operation of the selected file if the input does not match the predetermined password of the selected file.

2. The electronic device as described in claim 1, wherein the input order of input elements of the input corresponds to a set order of the elements of the predetermined password, when receiving one input element from the input unit, the processing unit compares the input element with a corresponding element of the elements in the predetermined password, if the input element does not match the corresponding element of the elements in the predetermined password, the processing unit determines the input does not match the predetermined password.

3. The electronic device as described in claim 1, wherein the predetermined password for each encrypted file is a combination of characters.

4. The electronic device as described in claim 1, wherein the predetermined password for each encrypted file is an operation on a function key, or operations on a combination of function keys.

5. A method for managing file authorization of files stored on an electronic device, the electronic device storing at least one encrypted file and at least one predetermined password, each of the at least one encrypted file corresponding to one of the at least one predetermined password, the method comprising:
selecting a file in response to a file selection operation input through an input unit;
determining whether the selected file is an encrypted file when receiving an operation signal of the selected file;
receiving input through the input unit if the selected file is an encrypted file;
determining whether the input matches the predetermined password of the selected file;
processing the file in response to the operation signal if the input matches the predetermined password of the selected file; and
not responding to the operation of the selected file if the input does not match the predetermined password of the selected file.

6. The method as described in claim 5, wherein the input order of input elements of the input corresponds to a set order of the elements of the predetermined password, when receiving one input element from the input unit, the processing unit compares the input element with a corresponding element of the elements in the predetermined password, if the input element does not match the corresponding element of the elements in the predetermined password, the processing unit determines the input does not match the predetermined password.

7. The method as described in claim 5, wherein the predetermined password set for each encrypted file is a combination of characters.

8. The method as described in claim 5, wherein the predetermined password set for each at least one encrypted file is an operation on a function key, or operations on a combination of function keys.
